(19) United States
(12) Patent Application Publication
(10) Pub. No.: US 2026/0101276 A1
(43) Pub. Date: Apr. 9, 2026

(54) SYSTEMS AND METHODS FOR DYNAMIC 5G NETWORK SLICING CONFIGURATION

(71) Applicant: Congruex Group, LLC, Boulder, CO (US)

(72) Inventors: Herkole Sava, Centreville, VA (US); Michael Seymour, Dallas, TX (US)

(21) Appl. No.: 18/908,286

(22) Filed: Oct. 7, 2024

(51) Int. Cl. H04W 48/18; H04L 43/0888; H04W 48/16

(52) U.S. Cl. CPC H04W 48/18; H04L 43/0888; H04W 48/16

(57) ABSTRACT

A computer system for a dynamic non-uniform 5G network slicing configurations is provided. The computer system includes at least one processor in communication with at least one memory device. The at least one processor is programmed to: a) receive, from a client device, a network slice request including a plurality of parameters, wherein the plurality of parameters include an actual amount of data to be transferred, a data source location, a data destination location, and timing information; b) identify a plurality of network devices between the data source location and the data destination location; c) select a subset of the plurality of network devices between the data source location and the data destination; d) generate a network slice, not necessarily uniformly configured throughout the route/area of interest, using the subset of the plurality of network devices; and e) transfer the data via the network slice.

### BACKGROUND

The field of the disclosure relates generally to a dynamic 5G network slicing configuration, and more particularly, to systems and methods for using precise tonnage, connectivity length duration, time, and location information for dynamic 5G slicing based upon network APIs (Advanced Programming Interfaces).

Current best-effort services offered by a 5G network, or LTE (long-term evolution), may not guarantee timely transmission of large amounts of data that needs to be transferred within a certain amount of time due to congestions, location coverage, or other variations on wireless network conditions. Therefore, the user needs dedicated resources from the 5G network to transfer the data within certain required parameters (i.e., throughput, latency, jitter, et) and within a predefined time interval. However, defining those parameters irrespective of its specific needs (i.e., exact time, location, tonnage, etc.) could result in significantly higher fees to the user from 5G mobile network operators (MNO), or the 5G MNO may be unable to fulfill such a request.

In general, a 5G network configures its resources based on predefined, and static, requests coming from a user/client well in advance and without exact knowledge of total data tonnage to be transferred, or the time and route of client locations. Such configuration, known as Service Level Agreement, is then attempted to be honored by the 5G network against a certain charge/fee. Furthermore, such SLA are configured uniformly through the network (i.e. sites, areas of interests et), which in turn may impose severe constraint in wireless networks as some of the wireless sites required to meet such SLA may have overall capacity constraints. Therefore, ensuring such network slicing SLA throughout the area of interest may come at a cost to other best effort costumers attempting to use the wireless network at the same time that 5G slices are in effect. In order to facilitate 5G network and client interactions for such requests, 5G operator and telecom industry has been working on a set of network APIs that could be called directly from the user/client and request a specific network slice based on its requirements. However, such approaches are based on prior predefined application requirements or 5G network configurations, which could be less than optimal for both 5G network capacity and operation. Additionally, this approach may lead to unnecessarily configuring a large number of wireless sites with such request due to unknown prior user location, which artificially reduced 5G network resources, its optimal operations, or increases the probability of such request being accepted. In addition, network slices have been envisaged to be programed uniformly throughout the sites/area of interests without having the flexibility to configure differently from site to site, which may impose unnecessarily network constraint in the case of a predefined tonnage-based connectivity request.

### BRIEF DESCRIPTION

In one aspect, a computer system for dynamic 5G network slicing configurations is provided. The computer system may include one or more local or remote processors, servers, computing devices or classical computing devices, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system includes at least one processor in communication with at least one memory device. The at least one processor is programmed to: a) receive, from a client device, a network slice request including a plurality of parameters, wherein the plurality of parameters include an actual amount of data to be transferred, a data source location, a data destination location, timing information, and the exact route where those client devices will be transmitting from; b) identify a plurality of network devices between the data source location and the data destination location; c) select a subset of the plurality of network devices between the data source location and the data destination; d) generate a network slice, not necessarily uniformly configured throughout the route/area of interest, using the subset of the plurality of network devices; and e) transfer the data via the network slice. The computer system may include additional, less, or alternate functionality, including that discussed elsewhere herein.

In another aspect, a computer-implemented method for dynamic 5G network slicing configurations is provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. The computer-implemented method may include: a) receive, from a client device, a network slice request including a plurality of parameters, wherein the plurality of parameters include an actual amount of data to be transferred, a data source location, a data destination location, timing information, and the exact route where those client devices will be transmitting from; b) identify a plurality of network devices between the data source location and the data destination location; c) select a subset of the plurality of network devices between the data source location and the data destination; d) generate a network slice, not necessarily uniformly configured throughout the route/area of interest, using the subset of the plurality of network devices; and e) transfer the data via the network slice. The computer-implemented method may include additional, less, or alternate functionality, including that discussed elsewhere herein.

In a further aspect, at least one non-transitory computer-readable storage medium with instructions stored thereon that is provided. Tn response to execution by at least one processor, cause the at least one processor to: a) receive, from a client device, a network slice request including a plurality of parameters, wherein the plurality of parameters include an actual amount of data to be transferred, a data source location, a data destination location, timing information, and the exact route where those client devices will be transmitting from; b) identify a plurality of network devices between the data source location and the data destination location; c) select a subset of the plurality of network devices between the data source location and the data destination; d) generate a network slice, not necessarily uniformly configured throughout the route/area of interest, using the subset of the plurality of network devices; and e) transfer the data via the network slice. The computer-executable instructions may include additional, less, or alternate functionality, including that discussed elsewhere herein.

Embodiments of the system provide advantages as described herein. Other advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a client-side process for setting up a dynamic 5G network slice in accordance with at least one embodiment.

FIG. 2 illustrates a server-side process for setting up and executing a dynamic 5G network slice in accordance with at least one embodiment.

FIG. 3 illustrates a timing diagram of a process of setting up and executing a dynamic 5G network slice in accordance with at least one embodiment.

FIG. 4 illustrates an environment for setting up a dynamic network slice using the processes shown in FIGS. 1-3.

FIG. 5 illustrates a simplified block diagram of an exemplary computer system for the processes shown in FIGS. 1-3.

FIG. 6 illustrates an exemplary configuration of a client computer device shown in FIG. 5, in accordance with one embodiment of the present disclosure.

FIG. 7 depicts an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION

The present embodiments may relate to, inter alia, systems and methods for precise time and location information for dynamic 5G slicing based upon network APIs. The systems and methods presented in this disclosure describe a 5G dynamic network slicing configuration through an API mechanism in the use cases when a device moves from location A to location B through a specific route and requires dedicated 5G network resources in order to guarantee transfer of data within a certain restricted timeframe. The scenario described herein assumes a business customer located at a point A (i.e., a site work location) that as a result of its work it has collected a large amount of data that needs to be transferred within a certain amount of time in order to ensure business continuity.

This disclosure proposes an innovative way to request a 5G network slice from the user/customer to MNO that takes into account the exact route of the user during a very determined time interval, as well as the exact needs of its communication during that time interval in terms of tonnage, average throughput, etc. Furthermore, the systems and methods described herein allow the 5G MNO to optimize its network resources, when applicable, by overprovisioning certain cell sites in order to complete the data transfer as fast as possible.

This approach is particularly applicable for business applications related to field operations (i.e., construction, mining, tower work companies, maintenance, and others) and when workforces move from one location to another within certain time is deemed critical for business optimal well-functioning. Furthermore, this submission is supports transferring large amount of data to the cloud within a certain amount of time in order to ensure work force business continuity without any delay due to data transfer requests. However, the proposed approach could be well extended to consumer use cases as well.

For the purposes of this discussion, 5G network slicing is a network architecture that enables the multiplexing of virtualized and independent logical networks on the same physical network infrastructure. Each network slice is an isolated end-to-end network tailored to fulfill diverse requirements requested by a particular application. This technology assumes a central role to support 5G mobile networks that are designed to efficiently embrace a plethora of services with very different service level requirements (SLR). The realization of this service-oriented view of the network leverages on the concepts of software-defined networking (SDN) and network function virtualization (NFV) that allow the implementation of flexible and scalable network slices on top of a common network infrastructure.

From a business model perspective, each network slice is administrated by a mobile network operator (MNO). The infrastructure provider (the owner of the telecommunication infrastructure) leases its physical resources to the MNOs that share the underlying physical network. According to the availability of the assigned resources, an MNO can autonomously deploy multiple network slices that are customized to the various applications provided to its own users. Accordingly, network slicing emerges as an essential technique in 5G networks to accommodate such different and possibly contrasting quality of service (QoS) requirements exploiting a single physical network infrastructure.

The basic idea of network slicing is to “slice” the original network architecture in multiple logical and independent networks that are configured to effectively meet the various services requirements. To quantitatively realize such concept, several techniques are employed, including network functions, virtualization, and orchestration. Network functions express elementary network functionalities that are used as “building blocks” to create every network slice. Virtualization provides an abstract representation of the physical resources under a unified and homogeneous scheme. In addition, it enables a scalable slice deployment relying on NFV that allows the decoupling of each network function instance from the network hardware it runs on. Orchestration is a process that allows coordination of all the different network components that are involved in the life cycle of each network slice. In this context, SDN is employed to enable a dynamic and flexible slice configuration.

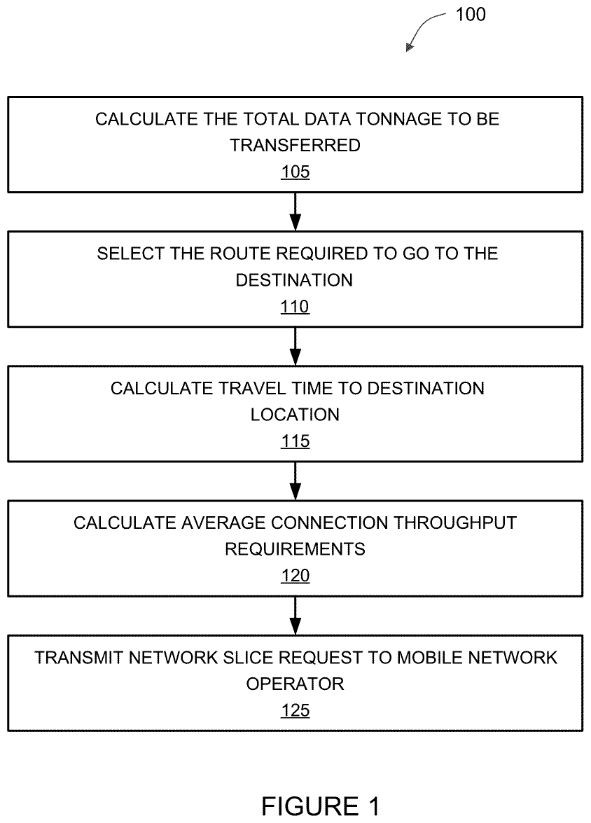

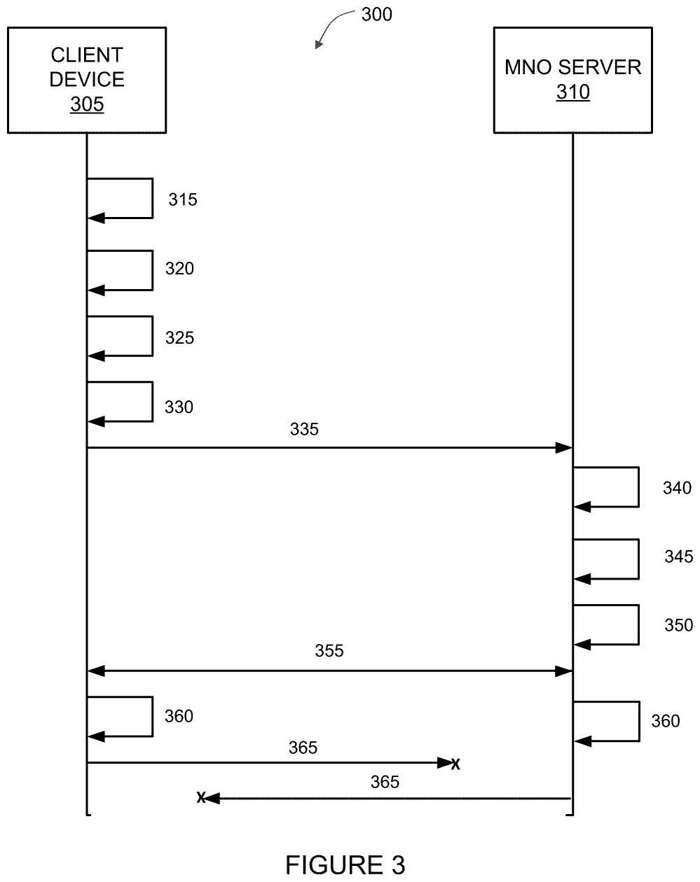

FIG. 1 illustrates a client-side process 100 for setting up a dynamic 5G network slice in accordance with at least one embodiment. In the exemplary embodiment, the steps of process 100 performed by a client device 305 (shown in FIG. 3).

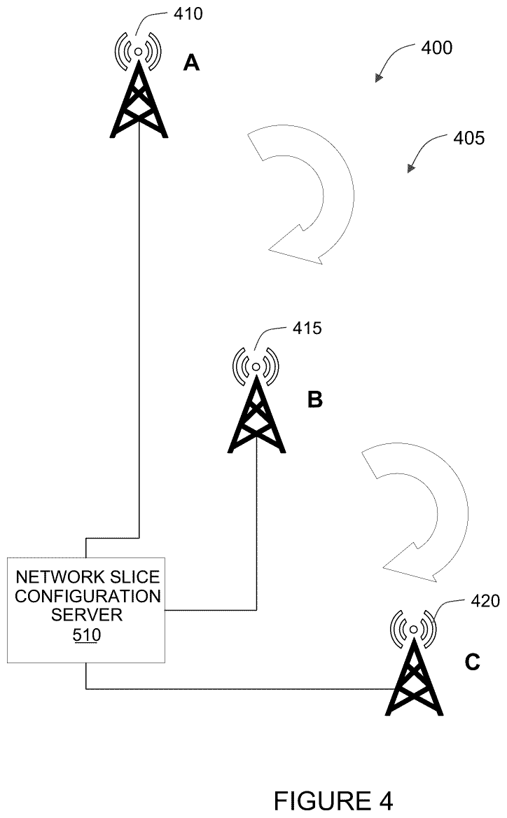

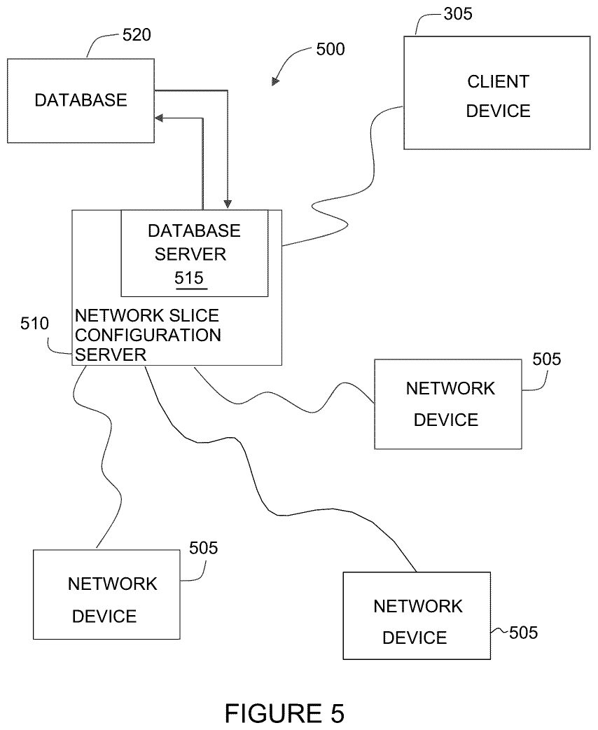

In the exemplary embodiment, the client device 305 calculates 105 the total data tonnage to be transferred data. The tonnage may include the size of the data to be transferred, such as in gigabytes (GB). The client device 305 may be in communication with one or more network devices 505 (shown in FIG. 5) that contain and/or have access to the data to be transferred. In other embodiments, the data tonnage is entered by a user. In some embodiments, the client device 305 is at a job site where the data is to be transferred from, such as tower A 410 (shown in FIG. 4).

In the exemplary embodiment, the client device 305 selects 110 the route required to physically travel from the current location 410 to the desired destination 420 (shown in FIG. 4). The route includes starting from the current location 410, such as tower A 410, to the desired destination 420, tower C 420 (shown in FIG. 4). For example, if the current location 410 is a tower 405 or other network device 505 that a crew is working on and the desired destination 420 is the next tower that the crew is working on, then the client device 305 determines the different travel routes for the crew to take to the desired destination. Then one of the user and/or the client device 305 and selects 110 the route that the crew will take. In some embodiments, the client device 305 presents the different routes to the user, who then selects one. In some embodiments, the client device 305 is in communication with one or more third-party servers (not shown) to determine the mapping data from physical travel from one point to the next including current traffic data.

In the exemplary embodiment, the client device 305 calculates 115 the travel time to the destination 420 using the selected route to physically travel from the current location 410 to the desired destination 420.

In the exemplary embodiment, the client device 305 calculates 120 the average connection throughput requirements for transferring the data from the network device 505 at the current location 410 to a network device 505 at the desired destination 420 based upon the travel time of the selected physical route between the current location 410 and the desired destination 420. This is timed so that the transfer would be complete by the time the crew reaches the desired destination 420. In some embodiments, there is additional buffer time added in, such as if the crew will be stopping, such as to go to lunch. Another reason for buffer time, may be that the crew will not need access to the data until after they have performed other tasks at the desired destination 420 or remaining tasks at the current location 410. One of the goals is to use a minimum of resources to transfer the data and to not interfere with other resources being used on the network. Furthermore, by using a minimum of resource in a just in time manner, the user keeps their usage costs low.

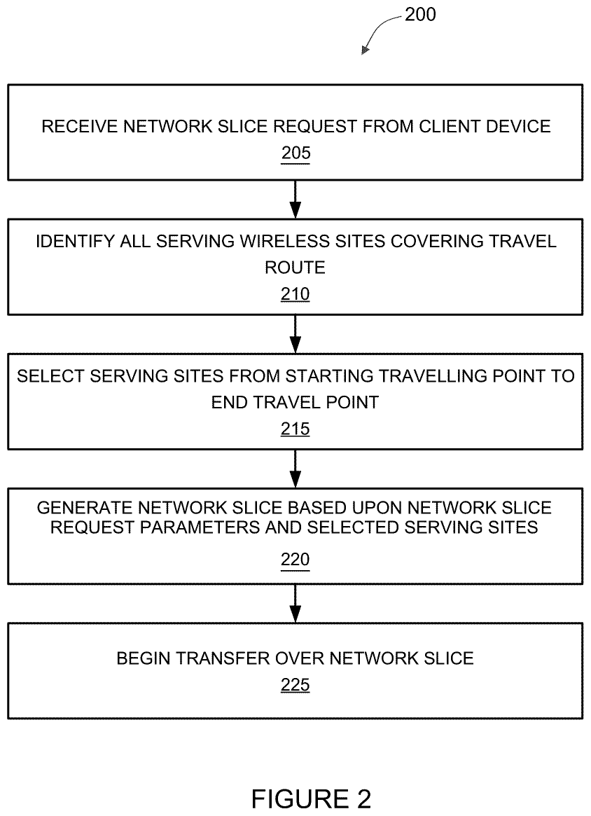

In the exemplary embodiment, the client device 305 transmits 125 a network slice request to a 5G mobile network operator (MNO) server 310 (shown in FIG. 3). In the exemplary embodiment, the network slice requirement includes one or more attributes of the desired network slice. These attributes may include, but are not limited to, source location, destination location, amount of data to be transferred, desired transfer rate, desired start and end times for the transfer, proposed network route, physical travel route, and/or any other information desired and supported by the MNO server 310. The MNO server 310 is configured to set-up a network slice based upon the request and conduct the transfer as described in process 200 (shown in FIG. 2).

FIG. 2 illustrates a server-side process 200 for setting up and executing a dynamic 5G network slice in accordance with at least one embodiment. In the exemplary embodiment, the steps of process 200 are performed by the MNO server 310 (shown in FIG. 3).

In the exemplary embodiment, the MNO server 310 receives 205 a network slice request from a client device 305 (shown in FIG. 3). In the exemplary embodiment, the network slice requirement includes one or more attributes of the desired network slice. These attributes may include, but are not limited to, source location, destination location, amount of data to be transferred, desired transfer rate, desired start and end times for the transfer, proposed network route, physical travel route, and/or any other information desired and supported by the MNO server 310.

In the exemplary embodiment, the MNO server 310 identifies 210 all serving wireless sites 415 covering the travel route from source location 410 to destination location 420 (all shown in FIG. 4). The wireless sites 415 each include one or more network devices 505 (shown in FIG. 1). In some embodiments, the MNO server 310 determines current and future loads on those network devices 505 at the serving sites 415.

In the exemplary embodiment, the MNO server 310 selects 215 serving sites 415 from starting to travel point 410 to end travel point 420. In some embodiments, the route is selected based on the network devices 505 that need to be used to route the data to the destination 420. The route selection may also be based upon the loads and usage of the network devices 505 between the current location 410 and the desired destination 420. In some embodiments, the MNO server 310 does not exactly follow the physical route due to network loads on specific network devices 505 or a lack of network devices 505 along the exact route.

In the exemplary embodiment, the MNO server 310 generates 220 a network slice based upon the parameters in the network slice request and the selected serving sites along the route. The network slice includes the throughput, start time, end time, and other parameters based upon the determined need to transfer the data from a network device 505 at the source 410 to a network device 505 at the destination 420. For example, an example network API definition may be used as follows:

| | |
|---|---|
| 5G_NetSlice_Req_Time_Loc { | |
| | -average_throughput_req (Mbps); |
| | -flexible_throuhgput_rate (Yes/No)/Boolean |

Parameter;

-time_interval_estimate (start_time, end_time)

(hour/min);

| | |
|---|---|
| | -travel_Route (https://googlemap_instance); |
| other map options also applicable | |
| | -total_data_tunnage_trasfer (MBits); |
| | -latency_transfer_request (msec); |
| | -jitter_transfer_request(msec); } |

In the exemplary embodiment, the MNO server 310 begins 225 the transfer of the data over the network slice. The MNO server 310 monitors 230 the transfer until the transfer is complete. Then the MNO server 310 deactivates 235 the network slice when the transfer is complete.

While the systems and methods described herein relate to transferring data for a work crew, one having skill in the art would understand that other uses for the systems and methods would be possible. For example, the methods described herein could be used for any manner of timed data transfers, where the size and the timing of the data transfer is known beforehand. For example, the data transfer could be for transferring data to the cloud, wherein the size of the data and the timing of the transfer are known.

FIG. 3 illustrates a timing diagram of a process 300 of setting up and executing a dynamic 5G network slice in accordance with at least one embodiment. In the exemplary embodiment, the steps of process 300 are performed by a client device 305 and a 5G mobile network operator (MNO) server 310. In some embodiments, the MNO server 310 is similar to or a part of a network slice configuration computer device 510 (shown in FIG. 5). In other embodiments, the MNO server 310 is in communication with a network slice configuration computer device 510.

In the exemplary embodiment, the client device 305 calculates 315 the total data tonnage to be transferred data. The tonnage may include the size of the data to be transferred, such as in gigabytes (GB). The client device 305 may be in communication with one or more network devices 505 (shown in FIG. 5) that contain and/or have access to the data to be transferred. In other embodiments, the data tonnage is entered by a user. In some embodiments, the client device 305 is at a job site where the data is to be transferred from, such as tower A 410 (shown in FIG. 4).

In the exemplary embodiment, the client device 305 selects 320 the route required to physically travel from the current location 410 to the desired destination 420 (shown in FIG. 4). The route includes starting from the current location 410, such as tower A 410, to the desired destination 420, tower C 420 (shown in FIG. 4). For example, if the current location 410 is a tower 405 or other network device 505 that a crew is working on and the desired destination 420 is the next tower that the crew is working on, then the client device 305 determines the different travel routes for the crew to take to the desired destination. Then one of the user and/or the client device 305 and selects 320 the route that the crew will take. In some embodiments, the client device 305 presents the different routes to the user, who then selects 320 one. In some embodiments, the client device 305 is in communication with one or more third-party servers (not shown) to determine the mapping data from physical travel from one point to the next including current traffic data.

In the exemplary embodiment, the client device 305 calculates 325 the travel time to the destination 420 using the selected route to physically travel from the current location 410 to the desired destination 420.

In the exemplary embodiment, the client device 305 calculates 330 the average connection throughput requirements for transferring the data from the network device 505 at the current location 410 to a network device 505 at the desired destination 420 based upon the travel time of the selected physical route between the current location 410 and the desired destination 420. This is timed so that the transfer would be complete by the time the crew reaches the desired destination 420. In some embodiments, there is additional buffer time added in, such as if the crew will be stopping, such as to go to lunch. Another reason for buffer time, may be that the crew will not need access to the data until after they have performed other tasks at the desired destination 420 or remaining tasks at the current location 410. One of the goals is to use a minimum of resources to transfer the data and to not interfere with other resources being used on the network. Furthermore, by using a minimum of resource in a just in time manner, the user keeps their usage costs low.

In the exemplary embodiment, the client device 305 transmits 335 a network slice request to a 5G mobile network operator (MNO) server 310 (shown in FIG. 3). In the exemplary embodiment, the network slice requirement includes one or more attributes of the desired network slice. These attributes may include, but are not limited to, source location, destination location, amount of data to be transferred, desired transfer rate, desired start and end times for the transfer, proposed network route, physical travel route, and/or any other information desired and supported by the MNO server 310. The MNO server 310 is configured to set-up a network slice based upon the request and conduct the transfer as described in process 200 (shown in FIG. 2).

In the exemplary embodiment, the MNO server 310 receives 335, from the client device 305, the network slice request including the plurality of parameters. The plurality of parameters includes, but not limited to, an actual amount of data to be transferred, a data source location 410, a data destination location 420, and timing information. In some embodiments, the timing information includes a start time for the transfer of data and an end time for the transfer of data. In some other embodiments, the timing information is based upon a projected amount of time to travel of a vehicle from a physical location of the data source location to a physical location of data destination location.

In the exemplary embodiment, the MNO server 310 identifies 340 a plurality of network devices 505 between the data source location 410 and the data destination location 420. In some embodiments, the plurality of network devices 505 include 5G network devices. In other embodiments, the plurality of network devices 505 include wireless network devices. In further embodiments, the data source location 410 and the data destination location 420 are wireless network towers 405 (shown in FIG. 4). In additional embodiments, at least one of the data source location 410 and the data destination location 420 are cloud storage.

In the exemplary embodiment, the MNO server 310 selects 345 a subset of the plurality of network devices 505 between the data source location 410 and the data destination location 420. In some embodiments, the MNO server 310 selects 345 the subset of the plurality of network devices 606 between the data source location 410 and the data destination location 420 based upon at least one of a current load and a future load of each of the plurality of network devices 505 between the data source location 410 and the data destination location 420.

In the exemplary embodiment, the MNO server 310 generates 350 a network slice using the subset of the plurality of network devices 505. In some embodiments, the MNO server 310 determines a throughput rate for the network slice based upon the timing information and the actual amount of data to be transferred.

In the exemplary embodiment, the MNO server 310 transfers 355 the data via the network slice.

In further embodiments, at least one of the client device 305 and the MNO server 310 monitors 360 the transfer of data via the network slice. Then the at least one of the client device 305 and the MNO server 310 deactivates 365 the network slice when the transfer of data is complete.

In some embodiments, the plurality of parameters further include timing interval when the data need to be transferred and the route of devices transferring the data during the transfer interval.

In additional embodiments, the network slice is not necessarily uniformly configured throughout the route or area of interest.

FIG. 4 illustrates an environment 400 for setting up a dynamic network slice using the processes 100, 200, and 300 (shown in FIGS. 1-3). In the exemplary embodiment, the environment 400 includes a plurality of towers 405. The towers 405 include a source tower 410, also known as the current location 410, one or more transfer sites 415, also know as serving sites 415 or wireless sites 415, and a destination location 420, also known as a destination site 420. All of the towers 405 include one or more network devices 505 (shown in FIG. 5) that allow for the transfer of data. This data transfer may be wireless, wired, or a combination there of, depending on the tower 405. These towers 405 allow for the transfer of data. In the exemplary embodiment, all of the towers 405 and their corresponding network devices 505 are in communication with a network slice configuration server 510. In some embodiments, the network slice configuration server 510 is in communication with one or more MNO servers 310 (shown in FIG. 3). In other embodiments, the network slice configuration server 510 includes or is a part of an MNO server 310. In still further embodiments, the network slice configuration server 510 is an MNO controller.

FIG. 5 illustrates an exemplary computer system 500 for performing the processes 100, 200, and 300 (shown in FIGS. 1-3). In the exemplary embodiment, the system 500 is used for controlling wireless infrastructure to set-up and use network slices to transfer data between network devices 505.

As described below in more detail, the network slice configuration computer device 510 may be programmed for using precise time and location information for dynamic 5G slicing based upon network APIs. In some embodiments, the network slice configuration computer device 510 may be programmed to a) receive, from a client device 305 (shown in FIG. 3), a network slice request including a plurality of parameters, wherein the plurality of parameters include an actual amount of data to be transferred, a data source location 410, a data destination location 420 (both shown in FIG. 4), and timing information; b) identify a plurality of network devices 505 between the data source location 410 and the data destination location 420; c) select a subset of the plurality of network devices 505 between the data source location 410 and the data destination 420; d) generate a network slice using the subset of the plurality of network devices 505; and e) transfer the data via the network slice.

In the example embodiment, client devices 305 are computers that include a web browser or a software application, which enables client devices 305 to communicate with a network slice configuration computer device 510 using the Internet, a local area network (LAN), or a wide area network (WAN). In some embodiments, the client devices 305 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 305 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the network slice configuration computer device 510 (also known as network slice configuration server 510) is a computer that include a web browser or a software application, which enables network slice configuration computer device 510 to communicate with client devices 305 using the Internet, a local area network (LAN), or a wide area network (WAN). In some embodiments, the network slice configuration computer device 510 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Network slice configuration computer device 510 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 515 is communicatively coupled to a database 520 that stores data. In one embodiment, the database 520 is a database that includes network equipment information. In some embodiments, the database 520 is stored remotely from the network slice configuration computer device 510. In some embodiments, the database 520 is decentralized. In the example embodiment, a person can access the database 520 via the client devices 305 by logging onto network slice configuration computer device 510.

Network devices 505 may be any device to provide communication between devices 505 and the ability to transmit and receive data from other devices 505. In the exemplary embodiment, the network slice configuration computer device 510 is in communication with a plurality of network devices 505 and is able to transmit instructions to those network devices 505 to configure them for the transfer of data. Furthermore, the network device 505 are capable of supporting virtual machines to set-up and execute network slices as described herein.

In some embodiments, the network devices 505 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Network devices 505 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

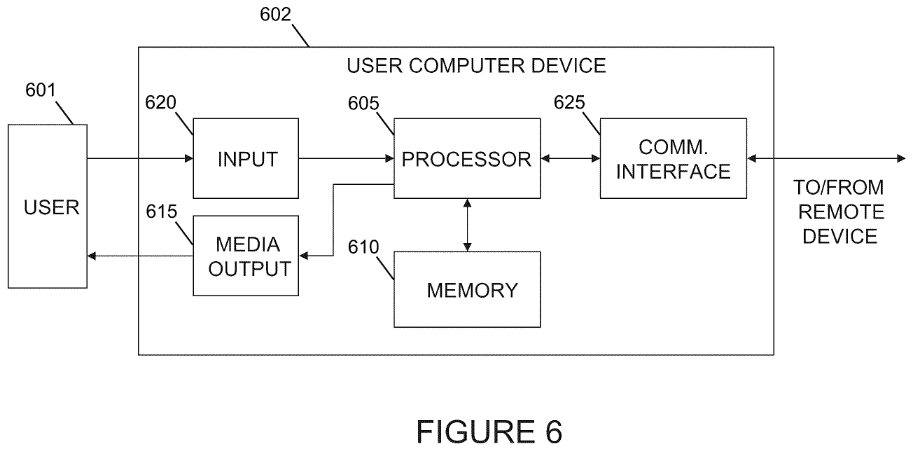

FIG. 6 depicts an exemplary configuration 600 of user computer device 602, in accordance with one embodiment of the present disclosure. In the exemplary embodiment, user computer device 602 may be similar to, or the same as, client device 305 (shown in FIG. 3) and network device 505 (shown in FIG. 5). User computer device 602 may be operated by a user 601.

User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing items of information provided by the network slice configuration computer device 510 (shown in FIG. 5). In some embodiments, user computer device 602 may include an input device 620 for receiving input from user 601. User 601 may use input device 620 to, without limitation, provide information either through speech or typing.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as network slice configuration computer device 510. Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from network slice configuration computer device 510. A client application may allow user 601 to interact with, for example, network slice configuration computer device 510. For example, instructions may be stored by a cloud service, and the output of the execution of the instructions sent to the media output component 615.

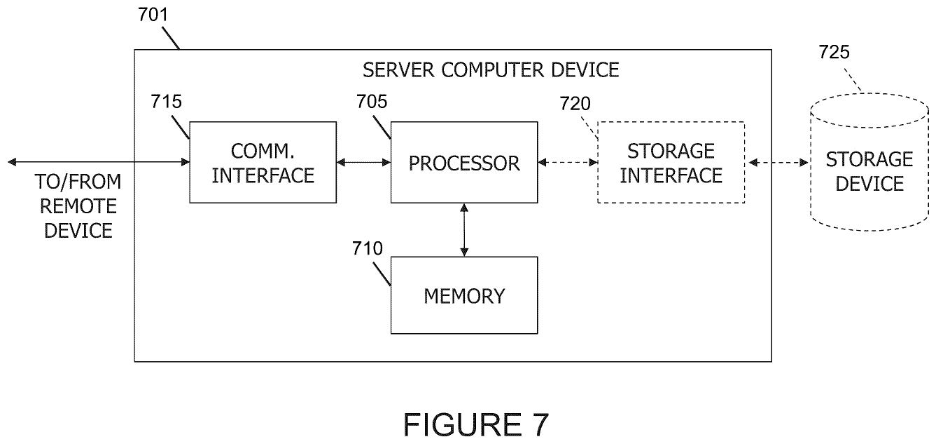

FIG. 7 depicts an exemplary configuration 700 of a server computer device 701, in accordance with one embodiment of the present disclosure. In the exemplary embodiment, server computer device 701 may be similar to, or the same as, MNO server 310 (shown in FIG. 3), network slice configuration computer device 510, and database server 515 (both shown in FIG. 4). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, network slice configuration computer device 510, MNO server 310, and client devices 305 (shown in FIG. 3) (for example, using wireless communication or data transmission over one or more radio links or digital communication channels). For example, communication interface 715 may receive input from client devices 305 via the Internet, as illustrated in FIG. 5.

Processor 705 may also be operatively coupled to a storage device 725. Storage device 725 may be any computer-operated hardware suitable for storing and/or retrieving data, such as, but not limited to, data associated with one or more models. In some embodiments, storage device 725 may be integrated in server computer device 701. For example, server computer device 701 may include one or more hard disk drives as storage device 725.

In other embodiments, storage device 725 may be external to server computer device 701 and may be accessed by a plurality of server computer devices 701. For example, storage device 725 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 725 via a storage interface 720. Storage interface 720 may be any component capable of providing processor 705 with access to storage device 725. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 725.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instruction such as illustrated in FIGS. 1-3.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for dynamic 5G network slicing configurations, the computer system including at least one processor in communication with at least one memory device, the at least one processor programmed to:
receive, from a client device, a network slice request including a plurality of parameters, wherein the plurality of parameters include an actual amount of data to be transferred, a data source location, a data destination location, and timing information;
identify a plurality of network devices between the data source location and the data destination location;
select a subset of the plurality of network devices between the data source location and the data destination location;
generate a network slice using the subset of the plurality of network devices; and
transfer the data via the network slice.

2. The computer system of claim 1, wherein the at least one processor is further programmed to determine a throughput rate for the network slice based upon the timing information and the actual amount of data to be transferred.

3. The computer system of claim 2, wherein the timing information includes a start time for the transfer of data and an end time for the transfer of data.

4. The computer system of claim 2, wherein the timing information is based upon a projected amount of time to travel of a vehicle from a physical location of the data source location to a physical location of data destination location.

5. The computer system of claim 1, wherein the at least one processor is further programmed to:
monitor the transfer of data via the network slice; and
deactivate the network slice when the transfer of data is complete.

6. The computer system of claim 1, wherein the at least one processor is further configured to select the subset of the plurality of network devices between the data source location and the data destination location based upon at least one of a current load and a future load of each of the plurality of network devices between the data source location and the data destination location.

7. The computer system of claim 1, wherein the plurality of parameters further include timing interval when the data need to be transferred and the route of devices transferring the data during the transfer interval.

8. The computer system of claim 1, wherein the plurality of network devices includes 5G network devices.

9. The computer system of claim 1, wherein the plurality of network devices includes wireless network devices.

10. The computer system of claim 1, wherein the data source location and the data destination location are wireless network towers.

11. The computer system of claim 1, wherein at least one of the data source location and the data destination location are cloud storage.

12. A computer-implemented method for dynamic 5G network slicing configurations implemented by a computer system including at least one processor in communication with at least one memory device, the method comprising:
receiving, from a client device, a network slice request including a plurality of parameters, wherein the plurality of parameters include an actual amount of data to be transferred, a data source location, a data destination location, and timing information;
identifying a plurality of network devices between the data source location and the data destination location;
selecting a subset of the plurality of network devices between the data source location and the data destination location;
generating a network slice using the subset of the plurality of network devices; and
transferring the data via the network slice.

13. The computer-implemented method of claim 12 further comprising determining a throughput rate for the network slice based upon the timing information and the actual amount of data to be transferred.

14. The computer-implemented method of claim 13, wherein the timing information includes a start time for the transfer of data and an end time for the transfer of data.

15. The computer-implemented method of claim 13, wherein the timing information is based upon a projected amount of time to travel of a vehicle from a physical location of the data source location to a physical location of data destination location.

16. The computer-implemented method of claim 12 further comprising:
monitoring the transfer of data via the network slice; and
deactivating the network slice when the transfer of data is complete.

17. The computer-implemented method of claim 12 further comprising selecting the subset of the plurality of network devices between the data source location and the data destination location based upon at least one of a current load and a future load of each of the plurality of network devices between the data source location and the data destination location.

18. The computer-implemented method of claim 12, wherein the plurality of network devices includes 5G network devices.

19. The computer-implemented method of claim 12, wherein the data source location and the data destination location are wireless network towers.

20. The computer-implemented method of claim 12, wherein at least one of the data source location and the data destination location are cloud storage.

21. At least one non-transitory computer-readable storage medium with instructions stored thereon that, in response to execution by at least one processor, cause the at least one processor to:
receive, from a client device, a network slice request including a plurality of parameters, wherein the plurality of parameters include an actual amount of data to be transferred, a data source location, a data destination location, and timing information;
identify a plurality of network devices between the data source location and the data destination location;
select a subset of the plurality of network devices between the data source location and the data destination location;
generate a network slice using the subset of the plurality of network devices; and
transfer the data via the network slice.
